(19) United States
(12) Patent Application Publication
(10) Pub. No.: US 2016/0342362 A1
(43) Pub. Date: Nov. 24, 2016

(54) VOLUME MIGRATION FOR A STORAGE AREA NETWORK

(71) Applicant: Hewlett Packard Enterprise Development LP, Houston, TX (US)

(72) Inventors: Murali Vaddagiri, Austin, TX (US); Jonathan Andrew McDowell, Fremont, CA (US); Siamak Nazari, Fremont, CA (US)

(73) Assignee: Hewlett Packard Enterprise Development LP, Houston, TX (US)

(21) Appl. No.: 15/112,796

(22) PCT Filed: Jan. 23, 2014
(86) PCT No.: PCT/US14/12784

§ 371 Date: Jul. 20, 2016

(51) Int. Cl. G06F 3/06

(52) U.S. Cl. CPC G06F 3/0647; G06F 3/0604; G06F 3/0644; G06F 3/067

(57) ABSTRACT

Disclosed herein is a storage array configured for volume migration. An example of the storage array includes migration logic, at least partially comprising hardware logic, to establish a pass-through volume in the storage array wherein the pass-through volume is not associated with local storage in the storage array, such that communication paths between a host computing device, a source volume, and the pass-through volume during are maintained during migration. The migration logic is configured to convert the pass-through volume to a destination volume in the storage array after data migration, wherein the destination volume is associated with local storage within the storage array.

### BACKGROUND

A storage array network (SAN) is a dedicated network that provides access to consolidated data storage. A SAN enables a host client device to access data volumes stored in a storage array. Due to various business needs, individual data volumes may be migrated from one storage array to another. To migrate data from a source volume of a source storage system to a destination volume of a destination storage system, the destination storage system typically sequentially retrieves data blocks from the source volume, and saves them to the destination volume.

### BRIEF DESCRIPTION OF THE DRAWINGS

Certain examples are described in the following detailed description and in reference to the drawings, in which:

FIG. 1 is a block diagram of a system configured for volume migration, in accordance with examples of the present disclosure;

FIGS. 2A, 2B, 2C, and 2D illustrate a process of volume migration;

FIG. 3 is a process flow diagram of a method for volume, in accordance with examples of the present disclosure; and

FIG. 4 is a block diagram of a tangible, non-transitory, computer-readable medium containing instructions configured for volume migration.

### DETAILED DESCRIPTION OF SPECIFIC EXAMPLES

A single host system or a cluster of multiple host systems may include data stored in a storage array, referred to herein as a source storage array. The host(s) and the source storage array may be connected via a storage array network (SAN) fabric, and may access one or more storage volumes on the source storage array. The techniques described herein include migration of particular storage volumes to a new storage array, referred to herein as a destination storage array, communicatively coupled to the SAN fabric. During migration host(s) may have access to the volumes on either the source or the destination storage arrays via a pass-through volume.

Examples described herein include a method and system for performing volume migration for storage arrays coupled in a storage array network (SAN). A source volume of storage, in a source storage array can be migrated to a destination storage array by creating the pass-through volume having no associated local storage within the destination storage array during migration. Although the pass-through volume is not associated with local storage within the destination storage array, the pass-through volume can be accessed by a host computer coupled to the storage array network. Input/output (I/O) commands sent from the host to the pass-through volume can be forwarded by the system to the volume in the source storage array during migration. Thus, the host has two communication paths to the source volume during migration—one directly connected through the source storage array and another connected via the pass-through volume. This may enable the host computer to maintain access to the data stored in the volume throughout the volume migration process. Additionally, the host computer can continue to access other source volumes that are not being migrated.

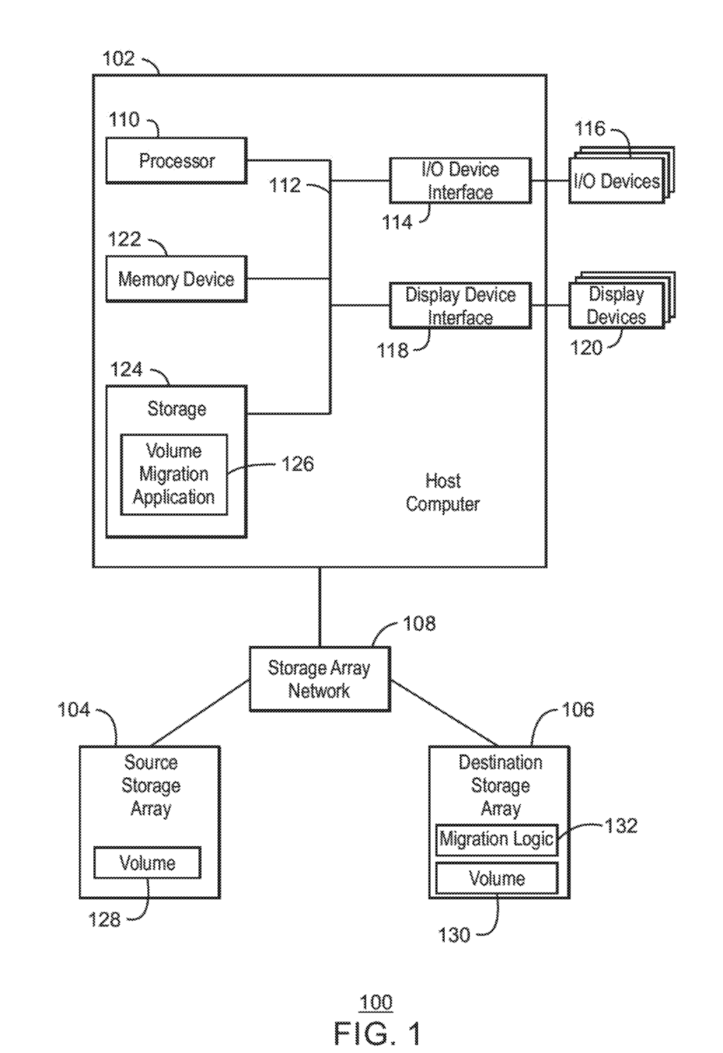

FIG. 1 is a block diagram of a system configured for volume migration, in accordance with examples of the present disclosure. The system 100 can include a host computer 102 coupled to a plurality of storage arrays 104, 106 via a storage array network (SAN) 108.

The host computer 102 may include, for example, a server computer, a mobile phone, laptop computer, desktop computer, or tablet computer, among others. The host computer 102 may include a processor 110 that is adapted to execute stored instructions. The processor 110 can be a single core processor, a multi-core processor, a computing cluster, or any number of other appropriate configurations.

The processor 110 may be connected through a system bus 112 (e.g., Peripheral Component Interconnect (PCI®), PCI Express®, Hyper Transport®, Serial Advanced Technology Attachment (ATA), among others) to an input/output (I/O) device interface 114 adapted to connect the host computer to one or more I/O devices 116. The I/O devices 116 may include, for example, a keyboard and a pointing device, wherein the pointing device may include a touchpad or a touchscreen, among others. The I/O devices 116 may be built-in components of the host computer 102, or may be devices that are externally connected to the host computer 102.

The processor 110 may also be linked through the system bus 112 to a display device interface 118 adapted to connect the host computer 102 to display devices 120. The display devices 120 may include a display screen that is a built-in component of the host computer 102. The display devices 120 may also include computer monitors, televisions, or protectors, among others, that are externally connected to the host computer 102.

The processor 110 may also be linked through the system bus 112 to a memory device 122. In some examples, the memory device 122 can include random access memory (RAM) (e.g., static RAM (SRAM), dynamic RAM (DRAM), embedded dynamic RAM (eDRAM), extended data out RAM (EDO RAM), double data rate RAM (DDR RAM), resistive RAM (RRAM®), phase-change RAM (PRAM), among others), read only memory (ROM) (e.g., Mask ROM, erasable programmable ROM (EPROM), electrically erasable programmable ROM (EEPROM), among others), non-volatile memory (phase-change memory (PCM), magnetoresistive RAM (MRAM), RRAM, Memristor), or any other suitable memory systems.

The processor 110 may also be linked through the system bus 112 to a storage device 124. The storage device 124 can include a volume migration application 126 containing instructions to direct the processor 110 to access in a source volume 128 in the source storage array 104. The volume migration application 126 may be a user interface to enable the user to interact with migration operation wherein data stored in the source volume 128 is to be migrated to a destination storage array 106, in which the host computer 102 maintains communication with a source volume 128 without interruption due to migration.

Migration logic 132 embedded in the destination storage array 106 can direct the destination storage array 106 to migrate data from the source volume 128 to a destination volume 130. The destination storage array 106 can establish a pass-through volume, as discussed in more detail below. Data can be copied from the source volume 128 to the pass-through volume. Meanwhile, any input/output commands sent to the pass-through volume from the host computer 102 can be forwarded to the source storage array 104. When data has been successfully copied to the pass-through volume, the pass-through volume may be converted into a standard destination volume associated with local memory of the destination storage array 106. Data in the pass-through volume may be copied over to the destination volume.

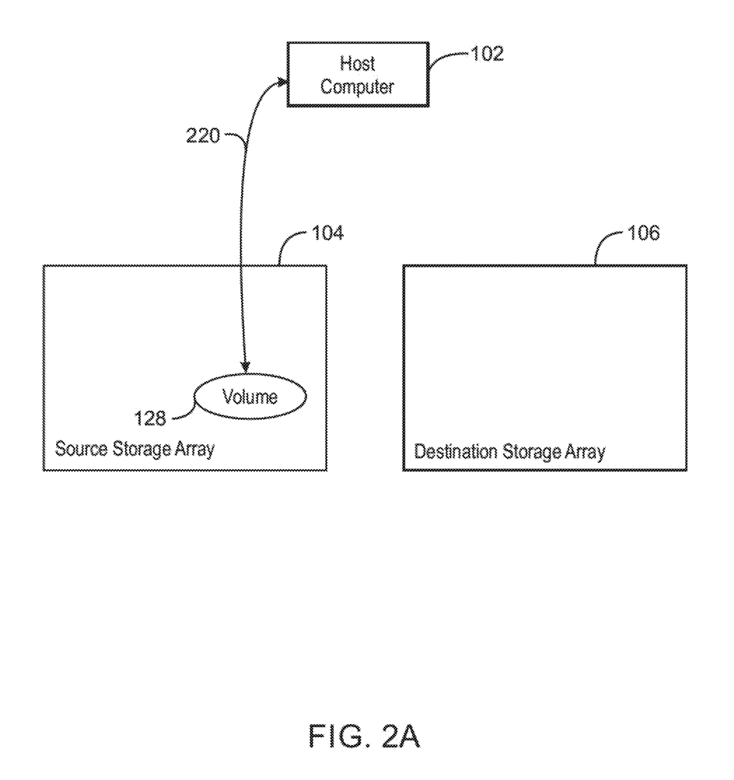

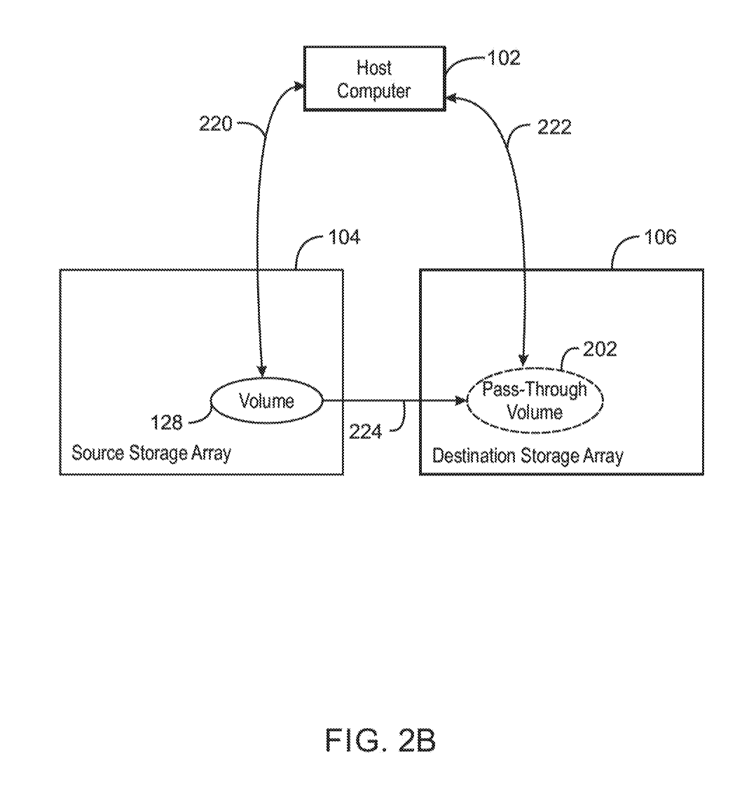

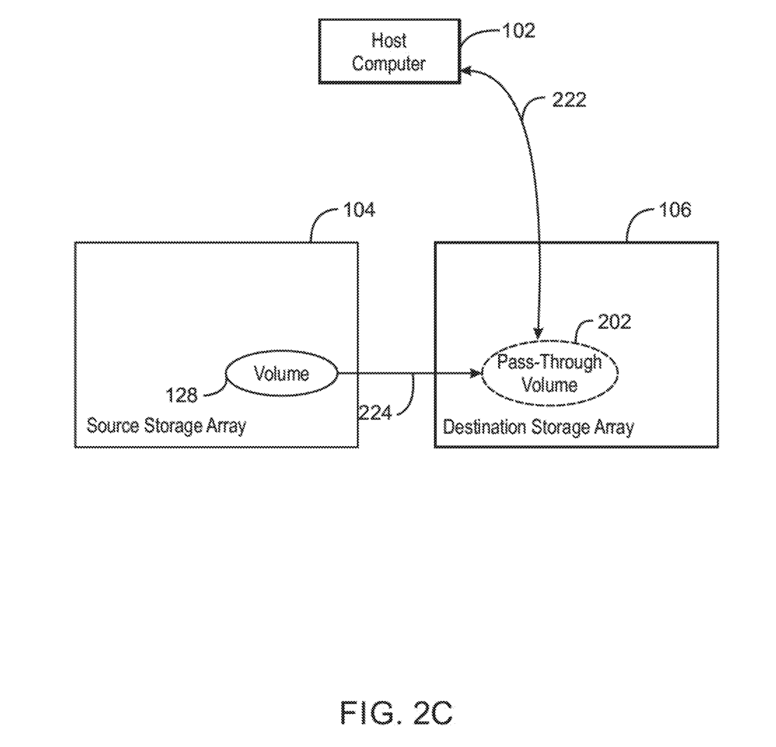

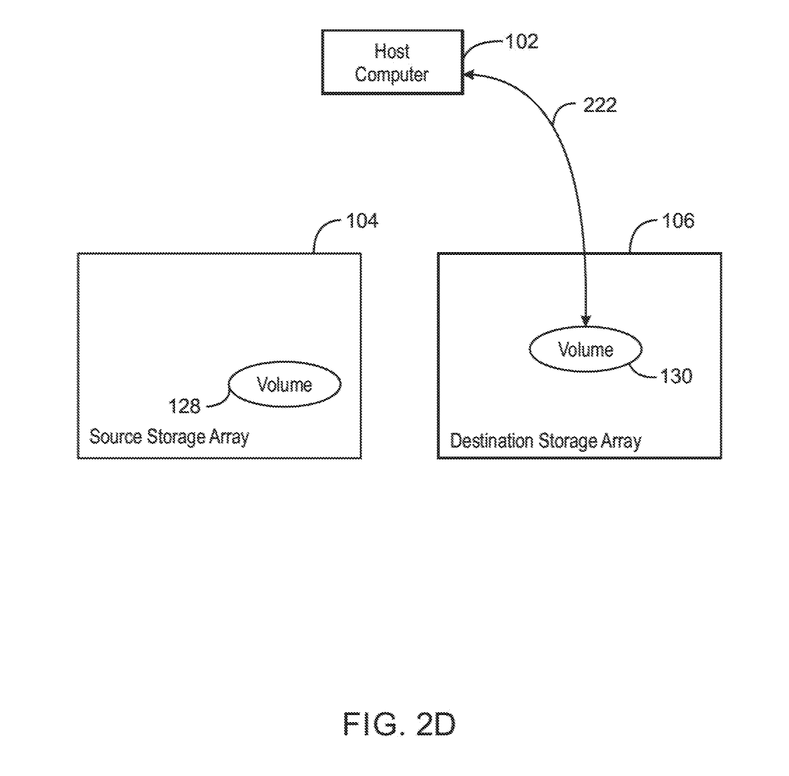

FIGS. 2A, 2B, 2C, and 2D illustrate a process of volume migration. A system 100, as described in FIG. 1, that includes a host computer 102, a source storage array 104, and a destination storage array 106 may include logic, such as the migration logic 132, to migrate storage volumes. For example, the destination storage array 106 may be configured to migrate a source volume 128 from the source storage array 104 to the destination storage array 106. Throughout the process of volume migration, the host computer 102 may maintain communication with the source volume 128 without interruption due to the migration based on the communication between the pass-through volume 202 and the source volume 128 during migration.

In FIG. 2A, the host computer 102 accesses the contents of the source volume 128 in the source storage array 104 by communicatively coupling with the source volume 128, as indicated by arrow 220. For example, the host computer 102 may couple with the source volume 128 via a target port group. Target port group may be a set of ports of the destination storage array 106 configured in an asymmetric access state. In some embodiments, the host computer 120 may couple with the source volume 128 in an asymmetric active/optimized state.

In FIG. 2B, the destination storage array 106 creates a pass-through volume 202. As indicated by arrow 222, the host computer 102 is communicatively coupled to the pass-through volume 202 in an active/optimized state. The pass-through volume 202 can be communicatively coupled to the source volume 128 in the source storage array 104. The pass-through volume 202 may be mapped to the source volume 128 such that input/output commands sent to the pass-through volume 202 from the host computer 102 are forwarded to the source volume 128 by the migration logic 132. The host computer 102 may be communicatively coupled to the source volume 128 via two different input/output paths: directly to the source storage array 104, and indirectly through the pass-through volume 202. The destination storage array 106 can implement copying of the source volume 128 to the destination source array 106 by migrating the data in the volume 128 to the pass-through volume 202, as indicated by arrow 224.

The destination storage array 106 can communicate with the source storage array 104 at various times during volume migration. The destination storage array 106, via the migration logic 132, can instruct the source storage array 104 to start reporting both target port groups (one corresponding to the source storage array 104 and other corresponding to the destination storage array 106) in Report Target Port Group (RTPG) responses. The communication path between the host computer 102 and the source storage array 104 may be under a source target port group, and the communication path through the destination storage array 106 may be under a destination target port group. In the example shown in FIG. 2B, the host computer 102 can access the source volume 128 either directly on the communication path to the source storage array 104 or on the communication path through the destination storage array 106. Further, the asymmetrical logical unit access (ALUA) state of both these groups may be Active-Optimized wherein the host computer can issue I/O commands through either of the two communication paths.

In FIG. 2C, the communication path between the host computer 102 and the source volume 128 in the source storage array 104 is placed in standby mode. Input/output commands sent from the host computer 102 to the pass-through volume 202 can continue to be forwarded by logic, such as the migration logic 132, to the source volume 128 in the source storage array 104.

The migration logic 132 may instruct the source storage array 104 to transition the source target port group state from Active-Optimized to standby causing Was between the host computer 102 and the source storage array 104 to cease. The destination target port group may remain in an Active-Optimized state, and the host computer 102 can access the source volume 128 through the pass-through volume 130.

In FIG. 2D, once data migration has completed, the communication path between the volume 128 in the source storage array 104 and the pass-through volume 202 is removed. The pass-through volume 202 can be converted into a standard volume 130 (referred to herein as a destination volume) having local storage within the destination storage array 106.

Various benefits may be afforded from the process of volume migration described above. The host computer 102 maintains continuous access to the volumes being migrated throughout the migration process. In other words, the host computer 102 does not lose access to the source volume 128 during migration. In some examples, the system 100 can selectively migrate individual volumes from the source storage array to the destination storage array using a pass-through volume in the destination storage array. Furthermore, by migrating a subset of volumes from the source to the destination, load balancing across the storage array network may be achieved, which can improve input/output performance on the host computer 102.

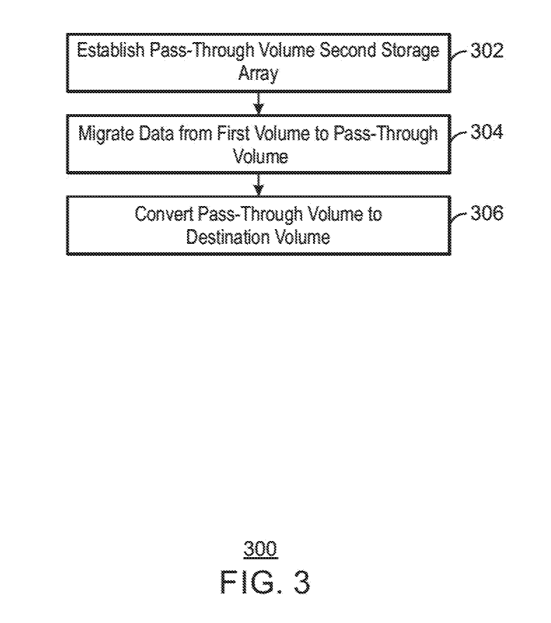

FIG. 3 is a process flow diagram of a method for volume migration in a storage array network (SAN), in accordance with examples of the present disclosure. The method 300 can be performed by a destination storage array 106 of a system 100 as illustrated in FIG. 1. The destination storage array may be configured to rate a volume from a source storage array to the destination storage array.

At block 302, a pass-through volume in the destination storage array is established. The pass-through volume can be communicatively coupled to the source volume and to the host computer. The pass-through volume may be mapped to the source volume such that input/output commands sent to the pass-through volume from the host computer are forwarded to the source volume.

At block 304, data from the source volume is migrated to he pass-through volume. The contents of the source volume are copied into the pass-through volume. In some examples, the communication path between the source volume and the host computer is placed in standby mode.

At block 306, the pass-through volume is converted to a destination volume in the destination storage array. The communication path between the source volume in the source storage array and the new destination volume in the destination storage array is removed or disabled.

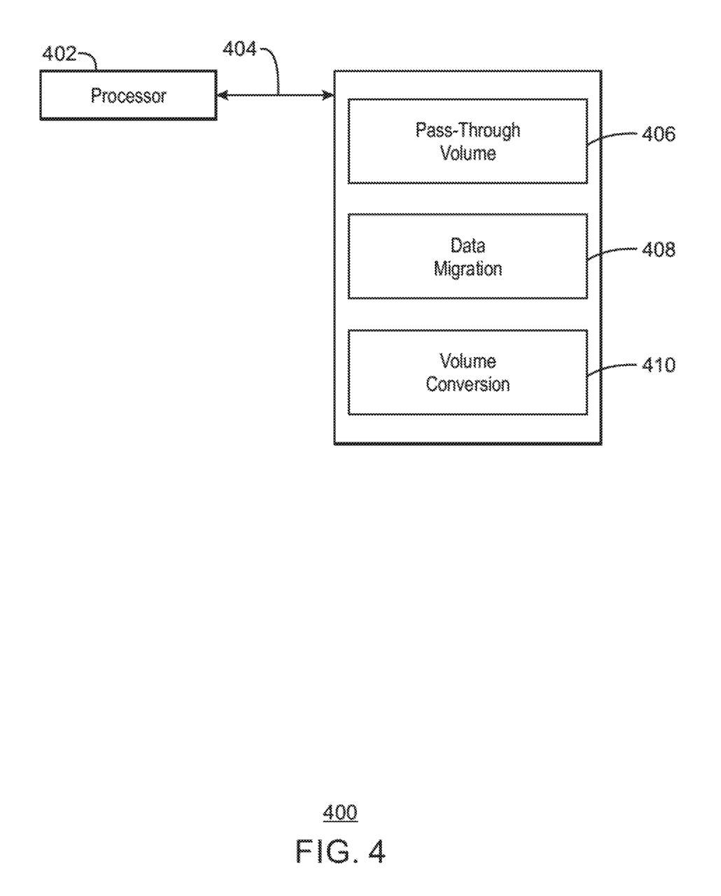

FIG. 4 is a block diagram of a tangible, non-transitory, computer-readable medium containing instructions configured for volume migration. The non-transitory, computer-readable medium 400 can include RAM, a hard disk drive, an array of hard disk drives, an optical drive, an array of optical drives, a non-volatile memory, a universal serial bus (USB) drive, a digital versatile disk (DVD), or a compact disk (CD), among others. The tangible, non-transitory computer-readable media 400 may be accessed by a processor 402 over a computer bus 404. Furthermore, the tangible, non-transitory computer-readable medium 400 may include instructions configured to direct the processor 402 to perform the techniques described herein.

As shown in FIG. 4, the various components discussed herein can be stored on the non-transitory, computer-readable medium 400. A volume access module 406 can contain instructions configured to access a source volume in a source storage array. A pass-through volume module 408 can contain instructions configured to establish a pass-through volume in a destination storage array. A data migration module 410 can contain instructions configured to migrate data from the source volume to the pass-through volume. A volume conversion module 412 can contain instructions configured to convert the pass-through volume to a destination volume in the destination storage array.

The block diagram of FIG. 4 is not intended to indicate that the tangible, non-transitory computer-readable medium 400 are to include all of the components shown in FIG. 4. Further, the tangible, non-transitory computer-readable medium 400 may include any number of additional components not shown in FIG. 4, depending on the details of the specific implementation.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed:

1. A storage array, comprising migration logic, at least partially comprising hardware logic, to:
establish a pass-through volume in the storage array wherein the pass-through volume is not associated with local storage in the storage array, and such that communication paths between a host computing device, a source volume in a source storage array, and the pass-through volume during are maintained during migration;
migrate data from the source volume to the pass-through volume; and
convert the pass-through volume to a destination volume in the storage array after data migration, wherein the destination volume is associated with local storage within the storage array.

2. The storage array of claim 1, the migration logic to map the pass-through volume to the source volume such that input/output commands sent to the pass-through volume from the host computer are to be forwarded to the source storage array.

3. The storage array of claim 1, the migration logic to place the communication path between the host computer and the source volume in a standby state as the storage array migrates data from the source volume to the pass-through volume.

4. The storage array of claim 1, the migration logic to disable a communication path coupling the source volume and the destination volume after data migration.

5. The storage array of claim 1, the migration logic to communicatively couple the host computer to the source volume via a Target Port Group in active/optimized state.

6. A method, comprising:
establishing a pass-through volume in a destination storage array wherein the pass-through volume is not associated with local storage in the destination storage array, and such that communication paths between a host computing device, a source volume in a source storage array, and the pass-through volume during are maintained during migration;
migrating data from the source volume to the pass-through volume; and
converting the pass-through volume to a destination volume in the destination storage array after data migration, wherein the destination volume is associated with local storage within the destination storage array.

7. The method of claim 6, comprising mapping the pass-through volume to the source volume such that input/output commands sent to the pass-through volume from the host computer are to be forwarded to the source storage array.

8. The method of claim 6, comprising plating the communication path between the processor and the source storage array in a standby state as the destination storage array migrates data from the source volume to the pass-through volume.

9. The method of claim 6, comp sing disabling a communication path coupling the source volume and the destination volume after data migration.

10. The method of claim 6, comprising communicatively coupling the host computer to the source volume via a Target Port Group in active/optimized state.

11. A tangible, non-transitory, computer-readable medium, comprising instructions configured to direct a processor to
establish a pass-through volume in a destination storage array wherein the pass-through volume is not associated with local storage in the destination storage array, and such that communication paths between a host computing device, a source volume in a source storage array, and the pass-through volume during are maintained during migration;
migrate data from the source volume to the pass-through volume; and
convert the pass-through volume to a destination volume in the destination storage array after data migration, wherein the destination volume is associated with local storage within the destination storage array.

12. The tangible, non-transitory, computer-readable medium of comprising instructions configured to direct a processor to map the pass-through volume to the source volume such that input/output commands sent to the pass-through volume from the host computer are to he forwarded to the source storage array.

13. The tangible, non--transitory, computer readable medium of claim 11, comprising instructions configured to direct a processor to place the communication path between the processor and the source storage array in a standby state as the destination storage array migrates data from the source volume to the pass-through volume.

14. The tangible, non-transitory, computer-readable medium of claim 11, comprising instructions configured to direct a processor to disable a communication path coupling the source volume and the destination volume after data migration.

15. The tangible, non-transitory, computer-readable medium of claim 11, comprising instructions configured to direct a processor to communicatively couple the host computer to the source volume via a Target Port Group in active/optimized state.
